(19) United States
(12) Patent Application Publication
(10) Pub. No.: US 2025/0080552 A1
(43) Pub. Date: Mar. 6, 2025

(54) METHOD, APPARATUS, DEVICE AND STORAGE MEDIUM FOR NETWORK SECURITY-BASED PAGE PROCESSING

(71) Applicant: Beijing Volcano Engine Technology Co., Ltd., Beijing (CN)

(72) Inventors: Chen ZHU, Beijing (CN); Ronghua XU, Beijing (CN); Jiahua SU, Beijing (CN); Lu JIN, Beijing (CN)

(21) Appl. No.: 18/818,502

(22) Filed: Aug. 28, 2024

(30) Foreign Application Priority Data
Aug. 29, 2023 (CN) 202311102711.5

(51) Int. Cl. H04L 9/40

(52) U.S. Cl. CPC H04L 63/1416; H04L 63/1425

(57) ABSTRACT

Embodiments of the disclosure discloses a method, apparatus, device and storage medium for network security-based page processing, and relates to the technical field of computer. The method comprises displaying, in an event display page corresponding to a target alarm notification, an event timeline corresponding to the target alarm notification and an object link corresponding to the target alarm notification, the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

### CROSS-REFERENCE TO RELATED APPLICATIONS

The present application claims priority to Chinese Patent Application No. 202311102711.5, filed on Aug. 29, 2023 and entitled “Method, Apparatus, Device and Storage Medium for Network Security-Based Page Processing”, the entirety of which is incorporated herein by reference.

### FIELD

Embodiment of the present disclosure relates to the technical field of computer, in particular to a method, apparatus, device and storage medium for network security-based page processing.

### BACKGROUND

With the rapid development of Internet technologies and computer technologies, the functions of network platforms become more and more abundant. Taking a cloud platform as an example, the cloud platform is a software and service platform constructed based on cloud computing technology, and can provide a reliable, flexible, and extensible manner to build, deploy and manage applications and services. Computing, storage, networking, databases, security, analytics, and other related services may generally be included.

In order to ensure the normal operation of the network platform, it is necessary to view and process the security alarm notification in time during the process of managing the network platform.

### SUMMARY

Embodiment of the disclosure provides a method, apparatus, device and storage medium for network security-based page processing, which can optimize an existing network security-based page processing scheme.

In a first aspect, an embodiment of the present disclosure provides a method for network security-based page processing, including:
displaying, in an event display page corresponding to a target alarm notification, an event timeline corresponding to the target alarm notification and an object link corresponding to the target alarm notification,
wherein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

In a second aspect, an embodiment of the present disclosure further provides an apparatus for network security-based page processing, including:
a timeline display module configured to display an event timeline corresponding to a target alarm notification in an event display page corresponding to the target alarm notification;
an object link display module configured to display, in the event display page corresponding to the target alarm notification, an object link corresponding to the target alarm notification while displaying the event timeline corresponding to the target alarm notification;
wherein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

In a third aspect, an embodiment of the present disclosure further provides an electronic device, including:
one or more processors, and
a storage device configured to store one or more programs,
when the one or more programs are executed by the one or more processors, causing the one or more processors to implement the method for network security-based page processing provided by embodiments of the present disclosure.

In a fourth aspect, an embodiment of the present disclosure further provides a storage medium including computer executable instructions, where the computer executable instructions, when executed by a computer processor, are configured to perform the method for network security-based page processing provided by embodiments of the present disclosure.

According to the page processing scheme based on network security provided by embodiments of the disclosure, the event timeline corresponding to the target alarm notification and the object link corresponding to the display target alarm notification are displayed in the event display page corresponding to the target alarm notification, the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship. By adopting the above technical solution, in the event display page of the alarm notification, both the event timeline and the object link are displayed, and the combination of the two can help the user quickly and comprehensively understand the progress of the associated events corresponding to the alarm notification as well as the connection between the associated objects involved in the associated events, which is conducive to the traceability and analysis of the alarm notification, and thus helps to improve the processing efficiency of the alarm notification.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a network security-based page processing method according to an embodiment of the present disclosure;

FIG. 2 is a schematic diagram of a page according to an embodiment of the present disclosure;

FIG. 3 is a schematic diagram of interface interaction according to an embodiment of the present disclosure;

FIG. 4 is a schematic diagram of another page according to an embodiment of the present disclosure;

FIG. 5 is a schematic flowchart of another network security-based page processing method according to an embodiment of the present disclosure;

FIG. 6 is a schematic structural diagram of a network security-based page processing apparatus according to an embodiment of the present disclosure; and

FIG. 7 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information interaction between multiple devices in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

FIG. 1 is a schematic flowchart of a network security-based page processing method according to an embodiment of the present disclosure.

As shown in FIG. 1, the method includes:

Step 101: displaying, in an event display page corresponding to a target alarm notification, an event timeline corresponding to the target alarm notification and an object link corresponding to the target alarm notification, where the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

In this embodiment of the present disclosure, the alarm notification may be a notification that is generated by the network platform in the running process and is used to reminder that there may be a situation that the network platform is running normally, for example, a notification for running safety related, the network platform may be, for example, a cloud platform, a specific type of the alarm notification, a specific trigger mechanism, and the like are not limited, for example, a malicious attack, a Trojan horse or a virus, or a system function exception. The target alarm notification may be understood as an alarm notification that needs to be viewed currently.

By way of example, after the event display page corresponding to the target alarm notification is entered, the event display page may include a first display area and a second display area, an event timeline corresponding to the target alarm notification is displayed in the first display area, and an object link corresponding to the target alarm notification is displayed in the second display area. The relative position relationship between the first display area and the second display area in the event display page is not limited, for example, may be a left-right relationship or an up-and-down relationship, so that the user can conveniently check the event timeline and the object link corresponding to the target alarm notification at the same time.

By way of example, before the alarm notification is triggered, a series of events usually occur in the network platform, thereby causing triggering of the alarm notification, recording an event related to triggering the alarm notification as an association event, after the alarm notification is triggered, backtracking the association event, determining event information of the association event, for example, an occurrence time of the association event, an object involved in the association event (which may be denoted as an association object), and specific event content in the association event, and the like, generating description information of the association event according to the event information, and displaying the corresponding description information in the visualized event unit based on the association event. The association object may include a resource object in the network platform (for example, an asset in the cloud platform), an account number, a sub-event or operation (for example, a preset query behavior exceeding a preset frequency threshold), and the like. For example, the description information of a certain association event may be: the process al (the process identifier pid is 123456) of the host A initiates an analysis query on the domain name xxx.xxx.cn by using the account ID123, and the associated object may include at least two of the host A, the process al, the account ID123, the domain name xxx.xxx.cn, and the resolution query operation. The event units are sorted and displayed according to the occurrence time of the associated events, for example, reverse order (time from near to far) or positive sequence (from far to near), helping the user to quickly know the occurrence process of each associated event by looking at the event timeline.

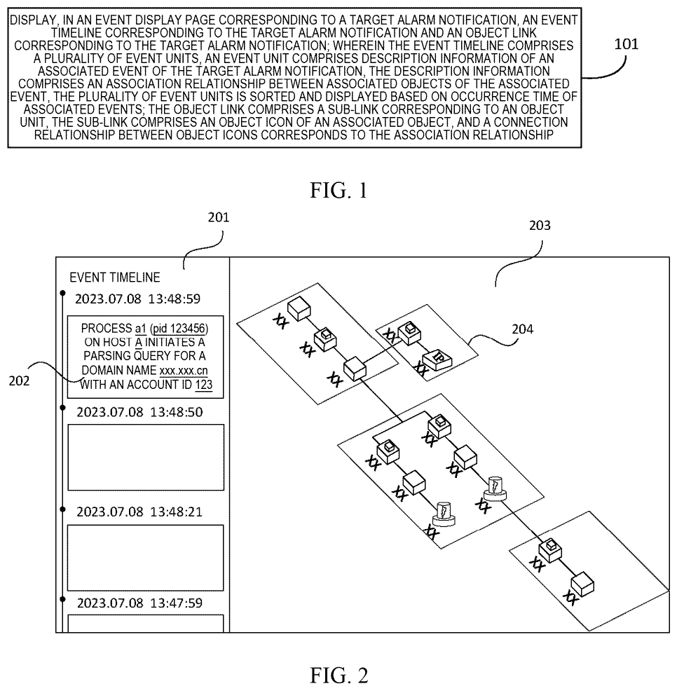

FIG. 2 is a schematic diagram of a page according to an embodiment of the present disclosure, as shown in FIG. 2, the event display page includes a first display area 201, an event timeline corresponding to the target alarm notification is displayed in the first display area 201, the event timeline includes a plurality of event units 202, a presentation form of the event unit 202 may be in a form of a card, and the event unit 202 includes description information of an association event. Each event unit 202 is associated with a corresponding occurrence time of an associated event, and each event unit 202 is arranged in a reversed order in a chronological order. When the current page cannot display all the event units, the user can trigger the movement of the event units in the event timeline through dragging and other operations, thereby displaying more event units.

By way of example, the object link includes a plurality of sub-links, the sub-link may be understood as a part of the link, each sub-link corresponds to one event unit, that is, the sub-link is in a one-to-one correspondence with the event unit, each sub-link generally includes an object icon (which may be understood as a node in the sub-link) of the associated object in the description information in the corresponding event unit, and the associated object is visually displayed in an icon form, helping the user to quickly know the type of the associated object, and the object icon may be associated with identification information such as the name of the associated object. When at least two event units include a same associated object, the associated object may be preferentially divided into a sub-link corresponding to a certain event unit, or may exist in a sub-link corresponding to the at least two event units at the same time, that is, the sub-links corresponding to different event units may have an intersection of associated object. The connection relationship between the object icons in the sub-links corresponds to the association relationship between the associated object in the corresponding description information, for example, the host A and the host B share the port C, and the object icons corresponding to the host A, the host B, and the port C may be sequentially connected. Different sub-links may be connected based on object icons corresponding to associated object included in the corresponding event units.

As shown in FIG. 2, the event display page includes a second display area 203, the object link is displayed in the first display area 203, the object link includes a sub-link 204 corresponding to the event unit, the sub-link 204 includes an object icon of an associated object in the corresponding event unit, the object icon is associated with a name of the associated object (represented by XX in FIG. 2), and the object icon included in each sub-link may be surrounded by using a closed line, so that the user can quickly distinguish different sub-links. For example, when the first sub-link indicates that the host A and the host B share the port C, and the second sub-link indicates that the host A accesses a certain IP address through the port D, the two sub-links may be connected by using the host A.

According to the method for page processing based on network security provided by embodiments of the disclosure, the event timeline corresponding to the target alarm notification and the object link corresponding to the display target alarm notification are displayed in the event display page corresponding to the target alarm notification, the event timeline comprises a plurality of event units, the event unit comprises description information of the association event of the target alarm notification, the description information comprises an association relationship between the associated object in the association event, the plurality of event units are sorted and displayed according to the occurrence time of the association event, the object link comprises a sub-link corresponding to the event unit, the sub-link comprises an object icon of the associated object, and the connection relationship between the object icons corresponds to the association relationship. By adopting the technical scheme, in the event display page of the alarm notification, the event timeline and the object link are displayed at the same time, and the combination of the event timeline and the object link can help the user to quickly and comprehensively know the connection event progress condition corresponding to the alarm notification and the connection between the associated object involved in the association event, so that the traceability and analysis of the alarm notification are facilitated, and the processing efficiency of the alarm notification is further improved.

In some embodiments, after displaying the event timeline corresponding to the target alarm notification and displaying the object link corresponding to the target alarm notification in the event display page corresponding to the target alarm notification, the method further includes: in response to a first trigger operation for a first event unit in the event timeline, changing a display style of the first event unit and changing the display style of a first sub-link corresponding to the first event unit. Therefore, the linkage interaction between the event timeline and the object link can be realized in the page, and the user is helped to more intuitively check the corresponding relationship between the event unit and the sub-link by changing the display style.

For example, the first event unit may be any event unit in the event timeline, and the first sub-link is a sub-link corresponding to the first event unit in the object link. The first trigger operation may be, for example, a hover operation or a click operation. The change of the display style of the first event unit may be, for example, bold, font color change or background color change. The change of the display style of the first sub-link may be, for example, a bold line emboldening, an icon display style change of an object icon (for example, an icon color change, a color change of a line bolding or an object identifier displayed in association), or a sub-link background color (which may be understood as a fill color in a closed line bounding area) change, or the like.

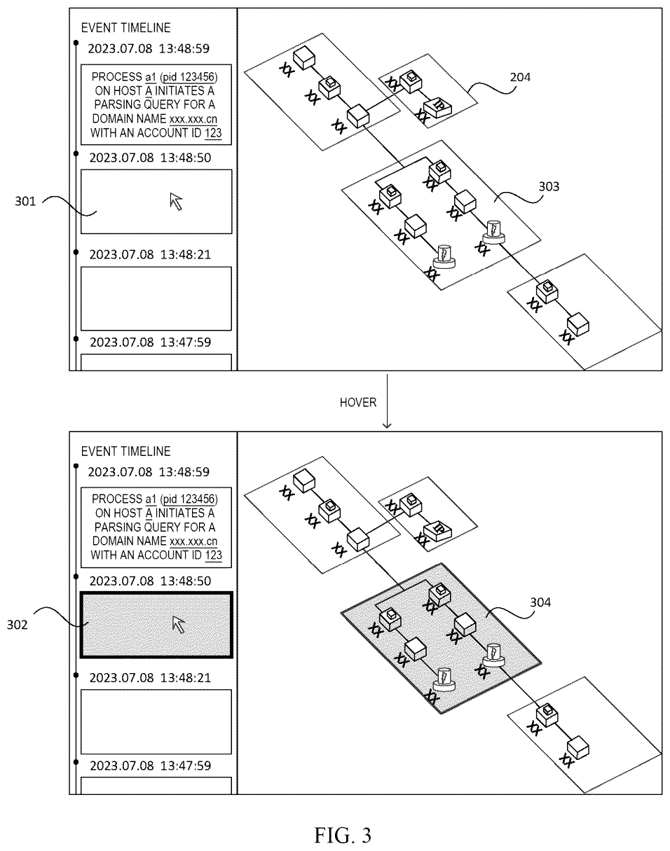

FIG. 3 is a schematic diagram of interface interaction according to an embodiment of the present disclosure, as shown in FIG. 3, if the user inputs a hover operation for the first event unit 301, the frame of the first event unit 301 is thickened and the background color changes from white to gray to become the first event unit 302 of the new display style, meanwhile, the closed line of the first sub-link 303 is bolded, and the background color of the sub-link changes from white to gray to become the first sub-link 304 of the new display style, so that the user can more quickly and intuitively view the correspondence between the event unit of interest and the sub-link.

In some embodiments, after displaying the event timeline corresponding to the target alarm notification and displaying the object link corresponding to the target alarm notification in the event display page corresponding to the target alarm notification, the method further includes: in response to a second trigger operation for a second event unit in the event timeline, changing a display style of the second event unit and changing the display style of a second sub-link corresponding to the second event unit. Therefore, the linkage interaction between the object link and the event timeline can be realized in the page, and the user is helped to more intuitively check the corresponding relationship between the sub-link and the event unit by changing the display style.

For example, the second sub-link may be any one of the object links, and the second event unit is an event unit corresponding to the second sub-link in the event timeline. The second trigger operation may be, for example, a hover operation or a click operation. The change of the display style of the second sub-link may be, for example, a bold line emboldening, an icon display style change of the object icon (for example, an icon color change, a color change of a line bolding or an object identifier displayed in association), or a sub-link background color (which may be understood as a fill color in the enclosed line bounding area) change. The display style of the second event unit may be changed, for example, may be a frame bold, a font color change, or a background color change.

In some embodiments, the description information includes an object identifier of the associated object; after displaying, in the event display page corresponding to the target alarm notification, an event timeline corresponding to the target alarm notification, and displaying an object link corresponding to the target alarm notification, the method further includes: in response to a third trigger operation for the target object identifier, entering an object detail page corresponding to a first associated object to which the target object identifier belongs. The target object identifier is an object identifier in the description information. Therefore, the user can quickly drill the details of the specific associated object based on the event timeline, and the alarm reason is more accurately traced.

For example, the object identifier included in the description information may be displayed in a link form, so as to prompt the user to trigger. The third trigger operation may be, for example, a click operation. The content in the object detail page may include, for example, information such as a name, an address, a working status, whether there is a risk, and working content in a preset time period.

In some embodiments, after displaying the event timeline corresponding to the target alarm notification and displaying the object link corresponding to the target alarm notification in the event display page corresponding to the target alarm notification, the method further includes: in response to a fourth trigger operation for a first target object icon in the object link, entering an object detail page corresponding to a second associated object to which the first target object identifier belongs. Therefore, the user can quickly drill a specific associated object based on the object link, and the alarm reason is more accurately traced.

For example, the fourth trigger operation may be, for example, a click operation.

In some embodiments, after displaying the event timeline corresponding to the target alarm notification and displaying the object link corresponding to the target alarm notification in the event display page corresponding to the target alarm notification, the method further includes: in response to a fifth trigger operation for a second target object icon in the object link, displaying, in an associated region of the second target object icon, object information of a third associated object to which the second target object icon belongs. Therefore, the user can quickly view the object information of different associated object without switching the page, more information of the associated object is obtained, and the alarm reason is more accurately traced.

For example, the fifth trigger operation may be, for example, a hover operation. The associated area of the second target object icon may be, for example, an area whose display distance to the second target object icon is less than a preset distance threshold, such as an upper left region, a right region, or a lower right region, and may be set according to actual needs.

In some embodiments, the third event unit includes a risk level identifier of a corresponding associated event, where the associated event corresponding to the third event unit has a security risk, display styles of risk level identifiers corresponding to different risk levels being different. Therefore, the risk degree of different association events can be quickly identified by the user, and richer reference information is provided for the traceability of the alarm reason and the processing of the alarm notification.

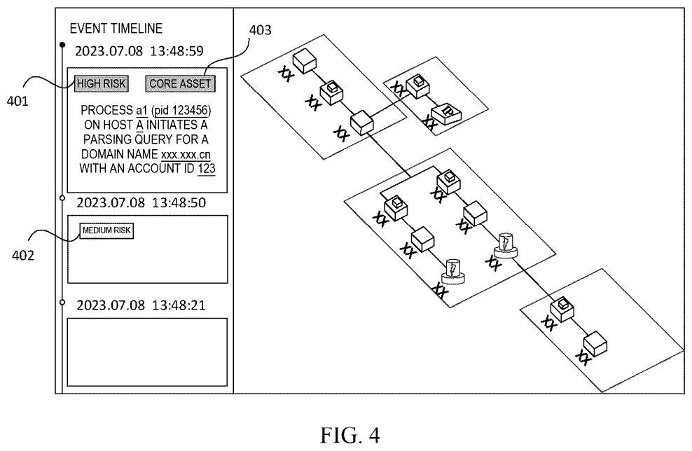

For example, the third event unit may be any event unit in the event timeline. Different types of display style identifier by the risk level may include different dimensions such as color, font or font size, and are not specifically limited. FIG. 4 is another page schematic diagram according to an embodiment of the present disclosure, as shown in FIG. 4, the first event unit includes a first risk level identifier 401, the display content is high risk, the second event unit includes a second risk level identifier 402, the display content is a medium risk, and a color of the first risk level identifier 401 is greater than a color of the second risk level identifier 402 to indicate that a risk level of the first risk level identifier 401 is higher.

In some embodiments, the fourth event unit includes a type identifier corresponding to a resource object of a predetermined type, where an associated object of description information in the fourth event unit comprises the resource object of the predetermined type. Therefore, when the associated object in the description information of an event unit includes the resource object of the preset type, the user can quickly learn the situation through the type identifier, and provide richer reference information for the tracing of the alarm reason and the processing of the alarm notification.

For example, the fourth event unit may be any event unit in the event timeline. For example, the resource object may be an asset in the network platform, may include hardware and/or software, and may include virtual machine for example, a virtual machine, a security group, a database, a public network IP (Internet Protocol), or the like. The preset type may be, for example, a resource type with a higher importance degree, such as a core asset. As shown in FIG. 4, it is assumed that the host A in the first event unit is a core asset in the network platform, and a corresponding type identifier 403 may be displayed.

In some embodiments, before displaying the event timeline corresponding to the target alarm notification and displaying the object link corresponding to the target alarm notification in the event display page corresponding to the target alarm notification, the method further includes: displaying a set of alarm notifications in an alarm notification display page of a cloud platform; and in response to a trigger operation for a target alarm notification in the set of alarm notifications, entering an event display page corresponding to the target alarm notification. Therefore, the alarm notification is aggregated in the alarm notification display page, the user is helped to quickly know the overall operation condition of the cloud platform, and the alarm notification of interest is selected for viewing.

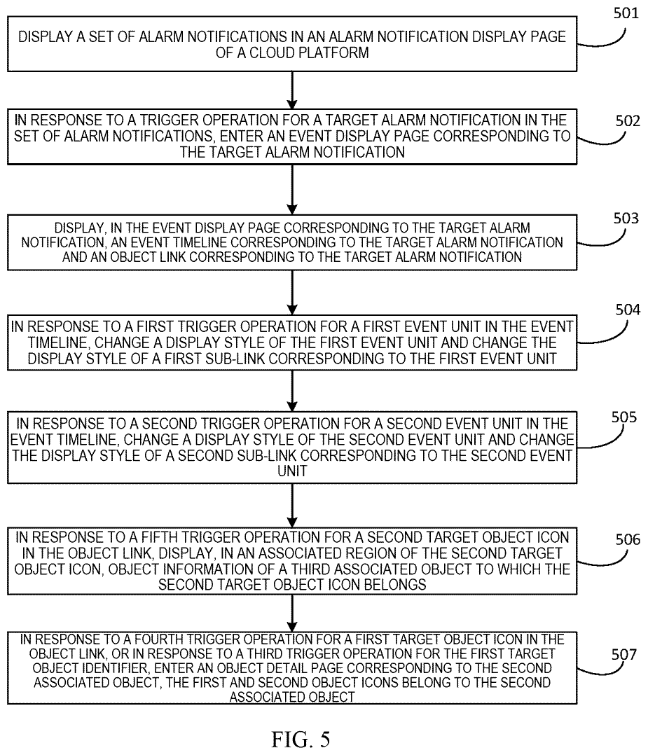

FIG. 5 is a schematic flowchart of another network security-based page processing method according to an embodiment of the present disclosure. Embodiments of the present disclosure are optimized on the basis of each of the optional embodiments in the above embodiments, taking the network platform as a cloud platform as an example, specifically, the method comprises the following steps.

Step 501: a set of alarm notifications is displayed in an alarm notification display page of a cloud platform.

For example, each alarm notification in the alarm notification set may be associated with an alarm level identifier, and is used to indicate an urgency degree of the alarm notification, to help the user select the target alarm notification.

Step 502, in response to a trigger operation for a target alarm notification in the set of alarm notifications, an event display page corresponding to the target alarm notification is entered.

For example, the target alarm notification is an alarm notification in the alarm notification set, and the user may trigger the target alarm notification through operations such as clicking, and then enter an event display page corresponding to the target alarm notification.

Step 503: in the event display page corresponding to the target alarm notification, an event timeline corresponding to the target alarm notification and an object link corresponding to the target alarm notification are displayed.

The description information includes an object identifier displayed in a link form of the associated object; in the event unit to which the association event having the security risk belongs, the event unit includes a risk level identifier of the corresponding association event; the association object describing the information includes a type identifier corresponding to the resource object of the preset type, and the preset type is, for example, used to indicate the core resource object.

Step 504: in response to a first trigger operation for a first event unit in the event timeline, a display style of the first event unit is changed and the display style of a first sub-link corresponding to the first event unit is changed.

Step 505: in response to a second trigger operation for a second event unit in the event timeline, a display style of the second event unit is changed and the display style of a second sub-link corresponding to the second event unit is changed.

Herein, the order of step 504 and step 505 is not limited. The step 505 may be performed first and then the step 504 may be performed. The order of the step 504 and step 505 is determined according to actual operation conditions of the user.

Step 506: in response to a fifth trigger operation for a second target object icon in the object link, object information of a third associated object to which the second target object icon belongs is displayed in an associated region of the second target object icon.

Step 507: in response to a fourth trigger operation for a first target object icon in the object link, or in response to a third trigger operation for the first target object identifier, an object detail page corresponding to the second associated object is entered, the first and second object icons belong to the second associated object.

According to the method for page processing based on network security provided by embodiments of the disclosure, an alarm notification is aggregated in an alarm notification display page, after a user triggers an alarm notification of interest, a corresponding event display page is entered, an event timeline and an object link are displayed in the event display page at the same time, description information, a risk level identifier and a resource object type identifier are included in the event unit in the event timeline, description information comprises an object identifier of the associated object, detailed event content and event progress conditions can be learned from the text description, the connection management between the visual icon and the icon of each associated object in the object link can be combined, the contact between object related to the event and the object can be more visually understood, after a certain event unit or a sub-link is triggered, the event unit and the sub-link corresponding to each other synchronously change the display style to form a linkage interaction, the object detail page can be entered in a manner of triggering the object icon in the object identifier or the sub-link, the user can be helped to quickly and comprehensively know the details of the associated object involved in the alarm notification, the rapid and accurate tracing and analysis are facilitated for the alarm notification, and the processing efficiency of the alarm notification is further improved.

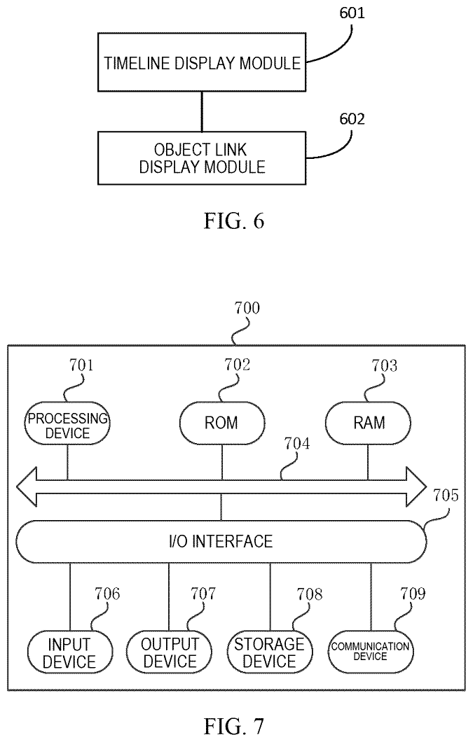

FIG. 6 is a schematic structural diagram of a network security-based page processing apparatus according to an embodiment of the present disclosure. Herein:
a timeline display module 601 configured to display an event timeline corresponding to a target alarm notification in an event display page corresponding to the target alarm notification; and
an object link display module 602 configured to display, in the event display page corresponding to the target alarm notification, an object link corresponding to the target alarm notification while displaying the event timeline corresponding to the target alarm notification, herein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

According to the network security-based page processing apparatus provided by embodiments of the disclosure, the event timeline corresponding to the target alarm notification and the object link corresponding to the display target alarm notification are displayed in the event display page corresponding to the target alarm notification, the event timeline comprises a plurality of event units, the event unit comprises description information of the association event of the target alarm notification, the description information comprises an association relationship between the associated object in the association event, the plurality of event units are sorted and displayed according to the occurrence time of the association event, the object link comprises a sub-link corresponding to the event unit, the sub-link comprises an object icon of the associated object, and the connection relationship between the object icons corresponds to the association relationship. By adopting the technical scheme, in the event display page of the alarm notification, the event timeline and the object link are displayed at the same time, and the combination of the event timeline and the object link can help the user to quickly and comprehensively know the connection event progress condition corresponding to the alarm notification and the connection between the associated object involved in the association event, so that the traceability and analysis of the alarm notification are facilitated, and the processing efficiency of the alarm notification is further improved.

Optionally, the apparatus further includes:
a first style changing module configured for, after displaying, in an event display page corresponding to a target alarm notification, an event timeline corresponding to the target alarm notification and an object link corresponding to the target alarm notification, in response to a first trigger operation for a first event unit in the event timeline, changing a display style of the first event unit and changing the display style of a first sub-link corresponding to the first event unit; and/or
a second style changing module configured to for after displaying, in an event display page corresponding to a target alarm notification, an event timeline corresponding to the target alarm notification and an object link corresponding to the target alarm notification, in response to a second trigger operation for a second event unit in the event timeline, changing a display style of the second event unit and changing the display style of a second sub-link corresponding to the second event unit.

Optionally, the description information includes an object identifier of the associated object, and the apparatus further includes:
s first detail page entry module configured for after displaying, in an event display page corresponding to a target alarm notification, an event timeline corresponding to the target alarm notification and an object link corresponding to the target alarm notification, in response to a third trigger operation for the target object identifier, entering an object detail page corresponding to a first associated object to which the target object identifier belongs, where the target object identifier is an object identifier in the description information.

Optionally, the apparatus further includes:
a second detail page entry module configured for after displaying, in an event display page corresponding to a target alarm notification, an event timeline corresponding to the target alarm notification and an object link corresponding to the target alarm notification, in response to a fourth trigger operation for a first target object icon in the object link, entering an object detail page corresponding to a second associated object to which the first target object identifier belongs.

Optionally, the apparatus further includes:
an object information display module configured for after displaying, in an event display page corresponding to a target alarm notification, an event timeline corresponding to the target alarm notification and an object link corresponding to the target alarm notification, display, in an event display page corresponding to a target alarm notification, in response to a fifth trigger operation for a second target object icon in the object link, displaying, in an associated region of the second target object icon, object information of a third associated object to which the second target object icon belongs.

Optionally, a third event unit comprises a risk level identifier of a corresponding associated event, where the associated event corresponding to the third event unit has a security risk, display styles of risk level identifiers corresponding to different risk levels being different.

Optionally, a fourth event unit comprises a type identifier corresponding to a resource object of a predetermined type, where an associated object of description information in the fourth event unit comprises the resource object of the predetermined type.

Optionally, the apparatus further includes:
a notification set display module configured for before displaying, in an event display page corresponding to a target alarm notification, an event timeline corresponding to the target alarm notification and an object link corresponding to the target alarm notification, displaying a set of alarm notifications in an alarm notification display page of a cloud platform; and
a page entry module configured for in response to a trigger operation for a target alarm notification in the set of alarm notifications, entering an event display page corresponding to the target alarm notification.

The network security-based page processing apparatus provided by the embodiments of the present disclosure may perform the network security-based page processing method provided by any embodiment of the present disclosure, and has functional modules and beneficial effects corresponding to the execution method.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 7 is a schematic structural diagram of an electronic device according to an embodiment of the present disclosure. FIG. 7 is a schematic structural diagram of an electronic device (such as the terminal device or server in FIG. 7) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 7 is merely an example, and should not impose any limitation on the functions and scope of use of the embodiments of the present disclosure.

As shown in FIG. 7, the electronic device 700 may include a processing device (for example, a central processing unit, a graphics processor, etc.) 701, which may perform various appropriate actions and processing according to a program stored in a read-only memory (ROM) 702 or a program loaded into a random access memory (RAM) 703 from a storage device 708. In the RAM 703, various programs and data required by the operation of the electronic device 700 are also stored. The processing device 701, the ROM 702, and the RAM 703 are connected to each other through a bus 704. An edit/output (I/O) interface 705 is also connected to the bus 704.

Generally, the following devices may be connected to the I/O interface 705: an input device 706 including, for example, a touch screen, a touchpad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may allow the electronic device 700 to communicate wirelessly or wired with other devices to exchange data. While FIG. 7 shows an electronic device 700 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 709, or installed from the storage device 708, or from the ROM 702. When the computer program is executed by the processing apparatus 701, the foregoing functions defined in the method of the embodiments of the present disclosure are performed.

The names of messages or information interaction between multiple devices in embodiments of the present disclosure are for illustrative purposes only and are not intended to limit the scope of such messages or information.

The electronic device provided by the embodiments of the present disclosure and the page processing method based on network security provided in the foregoing embodiments belong to the same inventive concept, and technical details not described in detail in this embodiment may refer to the foregoing embodiments, and this embodiment has the same beneficial effects as the foregoing embodiments.

An embodiment of the present disclosure provides a computer storage medium, where a computer program is stored, and when the program is executed by a processor, the method for processing a page based on network security provided in the foregoing embodiments is implemented.

An embodiment of the present disclosure provides a computer program product, including a computer program, where when the program is executed by a processor, the method for processing a page based on network security provided in the foregoing embodiments is implemented.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the electronic device, the electronic device is caused to: in an event display page corresponding to a target alarm notification, display an event timeline corresponding to the target alarm notification, and display an object link corresponding to the target alarm notification; wherein the event timeline comprises a plurality of event units, the event unit comprises description information of an association event of the target alarm notification, the description information comprises an association relationship between associated object in the association event, and the plurality of event units are sorted and displayed according to the occurrence time of the association event; the object link comprises a sub-link corresponding to the event unit, the sub-link comprises an object icon of the associated object, and a connection relationship between the object icons corresponds to the association relationship.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. In some cases, the name of the module does not constitute a limitation on the module itself, for example, the timeline display module may be further described as “displaying the event timeline corresponding to the target alarm notification” in the event display page corresponding to the target alarm notification.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, there is provided a method for network security-based page processing, comprising:
displaying, in an event display page corresponding to a target alarm notification, an event timeline corresponding to the target alarm notification and an object link corresponding to the target alarm notification,
Herein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

According to one or more embodiments of the present disclosure, after displaying, in an event display page corresponding to a target alarm notification, an event timeline corresponding to the target alarm notification and an object link corresponding to the target alarm notification, the method further comprises:
in response to a first trigger operation for a first event unit in the event timeline, changing a display style of the first event unit and changing the display style of a first sub-link corresponding to the first event unit; and/or
in response to a second trigger operation for a second event unit in the event timeline, changing a display style of the second event unit and changing the display style of a second sub-link corresponding to the second event unit.

According to one or more embodiments of the present disclosure, the description information comprises an object identifier of the associated object, and after displaying, in an event display page corresponding to a target alarm notification, an event timeline corresponding to the target alarm notification and an object link corresponding to the target alarm notification, the method further comprises:
in response to a third trigger operation for the target object identifier, entering an object detail page corresponding to a first associated object to which the target object identifier belongs, where the target object identifier is an object identifier in the description information.

According to one or more embodiments of the present disclosure, after displaying, in an event display page corresponding to a target alarm notification, an event timeline corresponding to the target alarm notification and an object link corresponding to the target alarm notification, the method further comprises:
in response to a fourth trigger operation for a first target object icon in the object link, entering an object detail page corresponding to a second associated object to which the first target object identifier belongs; and/or
in response to a fifth trigger operation for a second target object icon in the object link, displaying, in an associated region of the second target object icon, object information of a third associated object to which the second target object icon belongs.

According to one or more embodiments of the present disclosure, a third event unit comprises a risk level identifier of a corresponding associated event, wherein the associated event corresponding to the third event unit has a security risk, display styles of risk level identifiers corresponding to different risk levels being different.

According to one or more embodiments of the present disclosure, a fourth event unit comprises a type identifier corresponding to a resource object of a predetermined type, wherein an associated object of description information in the fourth event unit comprises the resource object of the predetermined type.

According to one or more embodiments of the present disclosure, before displaying, in an event display page corresponding to a target alarm notification, an event timeline corresponding to the target alarm notification and an object link corresponding to the target alarm notification, the method further comprises:
displaying a set of alarm notifications in an alarm notification display page of a cloud platform; and
in response to a trigger operation for a target alarm notification in the set of alarm notifications, entering an event display page corresponding to the target alarm notification.

According to one or more embodiments of the present disclosure, there is provided a network security-based page processing apparatus, including:
a timeline display module configured to display an event timeline corresponding to a target alarm notification in an event display page corresponding to the target alarm notification; and an object link display module configured to display, in the event display page corresponding to the target alarm notification, an object link corresponding to the target alarm notification while displaying the event timeline corresponding to the target alarm notification;
the event timeline comprises a plurality of event units, an event unit comprises description information of an associated event of the target alarm notification, the description information comprises an association relationship between associated objects of the associated event, the plurality of event units is sorted and displayed based on occurrence time of associated events;
the object link comprises a sub-link corresponding to an object unit, the sub-link comprises an object icon of an associated object, and a connection relationship between object icons corresponds to the association relationship.

According to one or more embodiments of the present disclosure, there is provided an electronic device, including:
one or more processors, and
a storage device configured to store one or more programs;
when the one or more programs are executed by the one or more processors, causing the one or more processors to implement the method for network security-based page processing provided by the embodiments of the present disclosure.

According to one or more embodiments of the present disclosure, there is provided a storage medium including computer executable instructions that, when executed by a computer processor, implementing the method for network security-based page processing provided in the embodiments of the present disclosure.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

What is claimed is:

1. A method for network security-based page processing, comprising:
displaying, in an event display page corresponding to a target alarm notification, an event timeline corresponding to the target alarm notification and an object link corresponding to the target alarm notification,
wherein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

2. The method of claim 1, wherein after displaying, in an event display page corresponding to a target alarm notification, an event timeline corresponding to the target alarm notification and an object link corresponding to the target alarm notification, the method further comprises:
in response to a first trigger operation for a first event unit in the event timeline, changing a display style of the first event unit and changing the display style of a first sub-link corresponding to the first event unit; and/or
in response to a second trigger operation for a second event unit in the event timeline, changing a display style of the second event unit and changing the display style of a second sub-link corresponding to the second event unit.

3. The method of claim 1, wherein the description information comprises an object identifier of the associated object, and after displaying, in an event display page corresponding to a target alarm notification, an event timeline corresponding to the target alarm notification and an object link corresponding to the target alarm notification, the method further comprises:
in response to a third trigger operation for the target object identifier, entering an object detail page corresponding to a first associated object to which the target object identifier belongs, wherein the target object identifier is an object identifier in the description information.

4. The method of claim 1, wherein after displaying, in an event display page corresponding to a target alarm notification, an event timeline corresponding to the target alarm notification and an object link corresponding to the target alarm notification, the method further comprises:
in response to a fourth trigger operation for a first target object icon in the object link, entering an object detail page corresponding to a second associated object to which the first target object identifier belongs; and/or
in response to a fifth trigger operation for a second target object icon in the object link, displaying, in an associated region of the second target object icon, object information of a third associated object to which the second target object icon belongs.

5. The method of claim 1, wherein a third event unit comprises a risk level identifier of a corresponding associated event, wherein the associated event corresponding to the third event unit has a security risk, display styles of risk level identifiers corresponding to different risk levels being different.

6. The method of claim 1, wherein a fourth event unit comprises a type identifier corresponding to a resource object of a predetermined type, wherein an associated object of description information in the fourth event unit comprises the resource object of the predetermined type.

7. The method of claim 1, wherein before displaying, in an event display page corresponding to a target alarm notification, an event timeline corresponding to the target alarm notification and an object link corresponding to the target alarm notification, the method further comprises:
displaying a set of alarm notifications in an alarm notification display page of a cloud platform; and
in response to a trigger operation for a target alarm notification in the set of alarm notifications, entering an event display page corresponding to the target alarm notification.

8. An electronic device comprising:
one or more processors, and
a storage device configured to store one or more programs,
when the one or more programs are executed by the one or more processors, causing the one or more processors to implement a method for network security-based page processing, the method comprising:
displaying, in an event display page corresponding to a target alarm notification, an event timeline corresponding to the target alarm notification and an object link corresponding to the target alarm notification,
wherein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

9. The electronic device of claim 8, wherein after displaying, in an event display page corresponding to a target alarm notification, an event timeline corresponding to the target alarm notification and an object link corresponding to the target alarm notification, the method further comprises:
in response to a first trigger operation for a first event unit in the event timeline, changing a display style of the first event unit and changing the display style of a first sub-link corresponding to the first event unit; and/or
in response to a second trigger operation for a second event unit in the event timeline, changing a display style of the second event unit and changing the display style of a second sub-link corresponding to the second event unit.

10. The electronic device of claim 8, wherein the description information comprises an object identifier of the associated object, and after displaying, in an event display page corresponding to a target alarm notification, an event timeline corresponding to the target alarm notification and an object link corresponding to the target alarm notification, the method further comprises:
in response to a third trigger operation for the target object identifier, entering an object detail page corresponding to a first associated object to which the target object identifier belongs, wherein the target object identifier is an object identifier in the description information.

11. The electronic device of claim 8, wherein after displaying, in an event display page corresponding to a target alarm notification, an event timeline corresponding to the target alarm notification and an object link corresponding to the target alarm notification, the method further comprises:
in response to a fourth trigger operation for a first target object icon in the object link, entering an object detail page corresponding to a second associated object to which the first target object identifier belongs; and/or
in response to a fifth trigger operation for a second target object icon in the object link, displaying, in an associated region of the second target object icon, object information of a third associated object to which the second target object icon belongs.

12. The electronic device of claim 8, wherein a third event unit comprises a risk level identifier of a corresponding associated event, wherein the associated event corresponding to the third event unit has a security risk, display styles of risk level identifiers corresponding to different risk levels being different.

13. The electronic device of claim 8, wherein a fourth event unit comprises a type identifier corresponding to a resource object of a predetermined type, wherein an associated object of description information in the fourth event unit comprises the resource object of the predetermined type.

14. The electronic device of claim 8, wherein before displaying, in an event display page corresponding to a target alarm notification, an event timeline corresponding to the target alarm notification and an object link corresponding to the target alarm notification, the method further comprises:
displaying a set of alarm notifications in an alarm notification display page of a cloud platform; and
in response to a trigger operation for a target alarm notification in the set of alarm notifications, entering an event display page corresponding to the target alarm notification.

15. A non-transitory storage medium comprising computer-executable instructions, wherein the computer-executable instructions, when executed by a computer processor, implementing a method for network security-based page processing, the method comprising:
displaying, in an event display page corresponding to a target alarm notification, an event timeline corresponding to the target alarm notification and an object link corresponding to the target alarm notification,
wherein the event timeline comprises a plurality of event units, an event unit comprises description information of an associated event of the target alarm notification, the description information comprises an association relationship between associated objects of the associated event, the plurality of event units is sorted and displayed based on occurrence time of associated events; the object link comprises a sub-link corresponding to an object unit, the sub-link comprises an object icon of an associated object, and a connection relationship between object icons corresponds to the association relationship.

16. The storage medium of claim 15, wherein after displaying, in an event display page corresponding to a target alarm notification, an event timeline corresponding to the target alarm notification and an object link corresponding to the target alarm notification, the method further comprises:
in response to a first trigger operation for a first event unit in the event timeline, changing a display style of the first event unit and changing the display style of a first sub-link corresponding to the first event unit; and/or
in response to a second trigger operation for a second event unit in the event timeline, changing a display style of the second event unit and changing the display style of a second sub-link corresponding to the second event unit.

17. The storage medium of claim 15, wherein the description information comprises an object identifier of the associated object, and after displaying, in an event display page corresponding to a target alarm notification, an event timeline corresponding to the target alarm notification and an object link corresponding to the target alarm notification, the method further comprises:
in response to a third trigger operation for the target object identifier, entering an object detail page corresponding to a first associated object to which the target object identifier belongs, wherein the target object identifier is an object identifier in the description information.

18. The storage medium of claim 15, wherein after displaying, in an event display page corresponding to a target alarm notification, an event timeline corresponding to the target alarm notification and an object link corresponding to the target alarm notification, the method further comprises:
in response to a fourth trigger operation for a first target object icon in the object link, entering an object detail page corresponding to a second associated object to which the first target object identifier belongs; and/or
in response to a fifth trigger operation for a second target object icon in the object link, displaying, in an associated region of the second target object icon, object information of a third associated object to which the second target object icon belongs.

19. The storage medium of claim 15, wherein a third event unit comprises a risk level identifier of a corresponding associated event, wherein the associated event corresponding to the third event unit has a security risk, display styles of risk level identifiers corresponding to different risk levels being different.

20. The storage medium of claim 15, wherein a fourth event unit comprises a type identifier corresponding to a resource object of a predetermined type, wherein an associated object of description information in the fourth event unit comprises the resource object of the predetermined type.
